(19) United States
(12) Patent Application Publication
(10) Pub. No.: US 2003/0136727 A1
(43) Pub. Date: Jul. 24, 2003

(54) Composite semipermeable membrane

(76) Inventors: Hideki Yamada, Otsu-shi (JP); Toshiyuki Tsuchiya, Otsu-shi (JP); Akihiro Ariji, Otsu-shi (JP); Atsuo Kumano, Otsu-shi (JP)

Correspondence Address: KENYON & KENYON, ONE BROADWAY, NEW YORK, NY, 10004, US

(21) Appl. No.: 09/580,294

(22) Filed: May 26, 2000

(30) Foreign Application Priority Data
May 27, 1999 (JP) 148552/1999

(51) Int. Cl. B01D 69/12

(52) U.S. Cl. 210/490; 210/500.21; 210/500.23; 210/500.38; 210/500.41

(57) ABSTRACT

The present invention relates to a composite semipermeable membrane, which is useful as a reverse osmosis membrane or a nano-filtration membrane and comprises a polysulfone porous support membrane and a polyamide ultrathin layer formed on one of the surfaces of the porous support membrane, the composite membrane having the characteristic that in the infrared absorption spectrum obtained from the surface of a polyamide ultrathin layer of the composite semipermeable membrane, the ratio T (=Aa/As) of absorption intensity Aa at the absorption peak revealing C═O of polyamide in the region of 1600-1700 cm⁻¹ to absorption intensity As at the absorption peak revealing polysulfone at a wavenumber around 1586 cm⁻¹ is at least 0.05 and not higher than. The composite semipermeable membrane thus obtained can attain conversion of sea water into fresh water, desalination of brackish water, recovery of valuable matter in aqueous solutions, treatment of waste water, and particularly removal of impurities (e.g., organic substances) from water.

### TECHNICAL FIELD

The present invention relates to a composite semipermeable membrane useful as a reverse osmosis membrane or a nano-filtration membrane. Specifically, the present invention relates to a composite semipermeable membrane having a specific property, which is obtained by forming a polymeric ultrathin layer having selective permeability on one of the surfaces of the porous support membrane. The composite semipermeable membrane thus obtained can attain conversion of sea water into fresh water, desalination of brackish water, recovery of valuable matter in aqueous solutions, treatment of waste water, and particularly removal of impurities (e.g., organic substances) from water.

### BACKGROUND ART

U.S. Pat. No. 4,980,061, Japanese Unexamined Patent Publication No. 95105/1987, PB Report 81-167215 and Japanese Unexamined Patent Publication No. 2842/1990 describe composite hollow fiber membranes wherein a polyamideic ultrathin layer is formed on the outer surface of a polysulfone porous hollow fiber membrane.

However, since the conventional composite hollow fiber membranes described in U.S. Pat. No. 4,980,061, Japanese Unexamined Patent Publication No. 95105/1987 have poor water permeability, high-pressure operation is required. Furthermore, publication nowhere describes organic substance removal performance of the composite hollow fiber membranes.

The composite hollow fiber membrane described in PB Report 81-167215 appears to have defects in the polymeric ultrathin layer because the performance tests show largely scattering results, and has poor separation property. Moreover, there is no description on organic substance removal performance of the composite hollow fiber membranes.

Japanese Unexamined Patent Publication No. 2842/1990 mentions organic substance removal performance of composite hollow fiber membranes, but merely describes membranes having high water permeability and low removal performance or those having high removal performance and low water permeability.

The object of the present invention is to obviate the defects of the prior art and provide a composite semipermeable membrane with excellent water permeability, high separation performance, and particularly excellent organic substance removal performance, by forming a composite semipermeable membrane comprising an optimized polyamide ultrathin layer.

### DISCLOSURE OF INVENTION

The present inventors carried out intensive research to achieve the above object and found the following: when a composite hollow fiber membrane having a polyamide ultrathin layer as formed on the outer surface of a polysulfone porous hollow fiber membrane has the feature that in the infrared absorption spectrum, the ratio T (=Aa/As) of absorption intensity Aa at the absorption peak revealing C═O of polyamide in the region of 1600-1700 cm⁻¹ to absorption intensity As at the absorption peak revealing polysulfone at a wavenumber around 1586 cm⁻¹ is within a specific range, the composite semipermeable membrane exhibits high separation performance, particularly high organic substance removal performance and high water permeability. The present inventors have achieved the above object, based on this finding.

The present invention provides a composite semipermeable membrane comprising a polysulfone porous support membrane and a polyamide ultrathin layer formed on one of the surfaces of the porous support membrane, the composite membrane having the characteristic that in the infrared absorption spectrum obtained from the surface of the polyamide ultrathin layer of the composite semipermeable membrane, the ratio T (=Aa/As) of absorption intensity Aa at the absorption peak revealing C═O of polyamide in the region of 1600-1700 cm⁻¹ to absorption intensity As at the absorption peak revealing polysulfone at a wavenumber around 1586 cm⁻¹ is at least 0.05 and not higher than 3. The polyamide ultrathin layer of the invention may comprise a crosslinked polyamide or a crosslinked polypiperazineamide. In a preferred embodiment, the composite semipermeable membrane of the invention has the features that its sucrose removal is 92% or more and its water permeability is at least 0.2 m³/m²/day, with respect to 0.1 wt. % aqueous sucrose solution, under an operating pressure of 0.3 MPa at a temperature of 25° C. and at pH of 6.5. The composite semipermeable membrane of the invention may be in the form of a hollow fiber membrane, and includes a composite membrane wherein a polyamide ultrathin layer is formed on the outer surface of the hollow fiber membrane.

The present invention further provides a process for producing the above composite semipermeable membrane. Specifically, the present invention provides a process for producing the composite semipermeable membrane comprising causing an interfacial polycondensation reaction between at least one multifunctional amine and at least one multifunctional acid halide on one of the surfaces of a polysulfone porous support membrane. More specifically, the present invention provides a process for producing the composite semipermeable membrane comprising bringing the polysulfone porous support membrane into contact with a controlled concentration of a multifunctional amine solution and then bringing the membrane into contact with a controlled concentration of a multifunctional acid halide solution, thus causing an interfacial polycondenstaion reaction.

The present invention is described below in detail.

A) Polysulfone Porous Support Membrane

There is no specific limitation on the polysulfone porous support membrane to be used in the invention, provided that the porous support membrane exhibits substantially no separation performance to the matter to be separated when used as a reverse osmosis membrane or a nano-filtration membrane, and serves as a support membrane for the polyamide ultrathin layer. The first surface of the polysulfone porous support membrane on which a polyamide ultrathin layer is formed preferably has micropores having a size of 0.05 μm or less, more preferably 0.03 μm or less, and having a size of 0.001 μm or more, more preferably 0.005 μm or more. It is preferable for the micropores to gradually become larger from the first surface to the opposite surface so that the permeation resistance of a fluid will not excessively increase. These micropores may have a net-shaped or a finger-shaped structure, or a mixture thereof. The polysulfone porous support membrane may be in the form of a hollow fiber membrane, a tubular membrane or a flat-sheet membrane, and mainly comprises a polysulfone resin. The polysulfone porous support membrane may contain a reinforcing material such as a woven or nonwoven fabric made of polyester or like materials.

The polysulfone porous support membrane to be used in the invention preferably achieves separation performance such that its dextran T70 removal is 50% or more with respect to an aqueous dextran T70 solution under a operating pressure of 0.1 MPa at 25° C., at a membrane surface average flow rate of 40 cm/second, at a permeate recovery ratio of less than 30%.

The polysulfone resin to be used in the invention may be selected from those known in the art, preferably aromatic polysulfone resins, and includes, for example, a polymer comprising a repeated unit represented by the following chemical formula 1

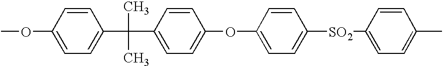

and a polymer comprising a repeated unit represented by the following chemical formula 2

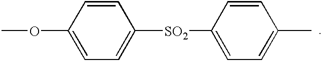

Preferably, the polysulfone resin is either of the above polymers. Most preferred is the polymer comprising a repeated unit represented by chemical formula 1.

The thickness of the polysulfone porous support membrane of the invention is not particularly limited. The thickness is suitably determined, in view of workability in the membrane formation, membrane area of a module, and pressure resistance. For example, the polysulfone porous support membrane in the form of a hollow fiber membrane preferably has an outer diameter of 100 μm to 2000 μm and an inner diameter of 30 μm to 1800 μm, and more preferably has an outer diameter of 150 μm to 500 μm and an inner diameter of 50 μm to 300 μm. Further, the polysulfone porous support membrane should at least resist pressure greater than the operating pressure applied as a composite membrane.

The polysulfone porous support membrane may be selected from various commercial products or can be produced by any known method for dry-wet membrane formation, etc. If necessary, the porous support membrane after its formation may be subjected to moist heating at 50° C. to remove a solvent, as disclosed in Japanese Unexamined Patent Publication No. 199007/1983 or may be treated with hot water at 90° C. or higher as disclosed in Japanese Unexamined Patent Publication No. 190,204/1985.

B) Polyamide Ultrathin Layer

The polyamide ultrathin layer of the invention is not particularly limited, only if it comprises a polyamide. The polyamide ultrathin layer is preferably a crosslinked polyamide ultrathin layer obtained by an interfacial polycondensation reaction between at least one multifunctional amine and at least one multifunctional acid halide. Examples of crosslinked polyamides include crosslinked polypiperazineamides and fully aromatic crosslinked polyamides, of which crosslinked polypiperazineamides are particularly preferred. It is preferable for the polyamide ultrathin layer to have a thickness as small as possible, so long as it has no pinholes. In view of stability in the membrane formation and permeability performance, the polyamide ultrathin layer preferably has a thickness of 1.0 μm or less, more preferably 0.5 μm or less. If necessary, a protective layer may be formed on the surface of the polyamide ultrathin layer having separation performance.

The polyamide ultrathin layer of the invention preferably comprises a crosslinked polyamide. One can easily test whether a polyamide ultrathin layer of a composite semipermeable membrane comprises a crosslinked polymer or not, based on solubility of the polyamide ultrathin layer in solvents, for example, by the following method. It is known that a polyamide obtained by a reaction between piperazine and isophthaloyl chloride is non-crosslinked linear polymer and dissolve in chloroform, etc. It is also known that a polyamide obtained by a reaction between m-phenylenediamine and isophthaloyl chloride is non-crosslinked linear polymer and dissolve in N-methyl-2-pyrrolidone, N,N-dimethylacetamide, etc. By contrast, crosslinked polyamide does not completely dissolve, even at a low concentration, in these solvents, and undissolved matter remains in the solvents. Using this property, the following test is carried out. Five dried pieces of the same composite semipermeable membrane, 1 g each, (comprising a polysulfone porous support membrane and a polyamide ultrathin layer) are immersed in 100 mL of chloroform, m-cresol, dichloromethane, N-methyl-2-pyrrolidone and N,N-dimethylacetamide, respectively, followed by stirring at room temperature. When undissolved matter remains in all these solvents, the polyamide ultrathin layer is regarded as a crosslinked polyamide layer. In the case that the polysulfone porous support membrane does not dissolve in the five solvents, the above operation is carried out after removing the polysulfone porous support membrane from the composite membrane by dissolution in a suitable solvent and separating the polyamide ultrathin layer. In the case that the composite semipermeable membrane further comprises reinforcing materials such as a woven or nonwoven fabric as a component, the above operation is carried out after removing the reinforcing material by peeling, dissolution or like methods. In the case that the composite semipermeable membrane is already used and has fouling substances on the surface of the membrane, the above operation is carried out after removing the fouling substances by an appropriate cleaning method in accordance with the fouling condition.

The infrared absorption spectrum in the present invention is preferably obtained by means of the Attenuated Total Reflection Infrared (ATR-IR) spectrometry. The ATR-IR spectrometry utilizes attenuated total reflection of infrared radiation at the surface of the object to be measured. The ATR-IR spectrometry more selectively detects and emphasizes the peak of the substances on the surface of the object to be measured than transmission infrared spectrometry. In the ATR-IR spectrometry, it is important that the sample and the internal reflection element are sufficiently contacted with pressure in order to obtain a spectrum with reproducibility. With an increased degree of pressure, adhesion between the internal reflection element and the object to be measured is improved, thereby generally increasing absorption intensity on the higher wavenumber value side. Therefore, the absorption intensity ratio T defined in the present invention is expected to increase. However, in the measurement of spectra of the composite semipermeable membrane of the present invention according to the ATR infrared absorption spectrometry, the polysulfone porous support membrane becomes dense through compressive deformation during the process of contact of the internal reflection element to the membrane with pressure, so that the absorption intensity revealing polysulfone increases and the absorption intensity ratio T decreases, contrary to the ordinary case. Therefore, spectra are measured at several points on the membrane, while the degree of contact with pressure of the internal reflection element is increased. When the ratio of absorption intensity revealing the polyamide to absorption intensity revealing polysulfone becomes a constant value, the spectrum obtained is regarded as the surface infrared absorption spectrum of the composite membrane.

FIG. 1 shows an ATR infrared absorption spectrum obtained from the surface of a polysulfone porous hollow fiber support membrane. FIG. 2 shows an ATR infrared absorption spectrum obtained from the outer surface of a composite hollow fiber membrane comprising a polysulfone porous support membrane and a polyamide ultrathin layer formed on the outer surface. FIG. 3 shows an ATR infrared absorption spectrum of a polyamide obtained by treating the composite membrane of FIG. 2 with chloroform to remove the polysulfone porous support membrane by dissolution and separating the polyamide. FIGS. 1 and 2 are ATR-IR spectra of hollow fiber membrane obtained in Comparative Example 1 and Example 1 shown later. A comparison of FIGS. 1-3 clearly shows that the absorption peak around 1586 cm⁻¹ reveals polysulfone and the absorption peak around 1630 cm^{31 1} reveals polyamide. It is known that the absorption peak around 1586 cm⁻¹ is assigned to C═C stretching vibration of the aromatic ring of polysulfone and the absorption peak around 1630 cm⁻¹ is assigned to C═O stretching vibration of the polyamide.

Infrared absorption peak revealing polyamide may fluctuate slightly with a variation in chemical composition. For example, in the case of polyamide obtained by reacting metaphenylenediamine and trimesoyl chloride, the absorption band assigned to the C═O stretching vibration of polyamide shifts to around 1660 cm⁻¹. In this case, the absorption intensity around 1660 cm⁻¹ is regarded as the absorption intensity of the absorption peak to reveal C═O of the polyamide in the range of 1600-1700 cm⁻¹ as defined in claim 1.

The ratio T (=Aa/As) of absorption intensity Aa at the absorption peak revealing C═O of polyamide in the region of 1600-1700 cm⁻¹ to absorption intensity As at the absorption peak revealing polysulfone at a wavenumber around 1586 cm⁻¹ is considered to mainly reflect the thickness of a polyamide ultrathin layer. The composite semipermeable membrane with a high absorption intensity ratio T comprises a polyamide ultrathin layer of large thickness. The composite semipermeable membrane with a low absorption intensity ratio T comprises a polyamide ultrathin layer of small thickness. To provide a composite membrane with high organic substance removal performance and high water permeability, the absorption intensity ratio T is preferably at least 0.05 and not higher than 3, more preferably at least 0.1 and not higher than 1.5. When the absorption intensity ratio T is higher than 3, the composite membrane has high organic substance removal performance but also has low water permeability because of an increased transmission resistance due to an excessive thickness of the polyamide ultrathin layer. When the ratio is lower than 0.05, the composite membrane has high water permeability but also has the following problems. It becomes difficult for the polyamide ultrathin layer to completely cover the whole polysulfone porous support membrane, thereby causing leakage or lowering organic substance removal performance. Furthermore, due to an excessively diminished thickness of the polyamide ultrathin layer, physical and chemical durability will decrease.

C) Process For Producing the Composite Semipermeable Membrane of the Invention

The composite semipermeable membrane can be produced by an interfacial polycondensation reaction between at least one multifunctional amine and at least one multifunctional acid halide on one of the surfaces of a polysulfone porous support membrane. Specifically, a polysulfone porous support membrane is brought into contact with a controlled concentration of an amine solution, followed by removing an excess of the amine solution from the surface of the membrane. Then the membrane is brought into contact with a controlled concentration of an acid halide solution, thereby causing an interfacial polycondensation reaction to form a composite semipermeable membrane. A process for producing the composite membrane will be described below.

Examples of multifunctional amines include aromatic amines and aliphatic amines. These amines may be used singly or in combination.

Aromatic amines that can be used in the invention are those having at least two amino groups in one molecule. Examples of aromatic amines having at least bifunctionality include m-phenylenediamine, p-phenylenediamine, 4,4′-diaminodiphenylamine, 4,4′-diaminodiphenyl ether, 3,4′-diaminodiphenyl ether, 3,3′-diaminodiphenylamine, 3,5-diaminobenzoates, 4,4′-diaminodiphenylsulfone, 3,3′-diaminodiphenylsulfone, 3,4′-diaminodiphenylsulfone, 1,3,5-triaminobenzene and mixtures thereof. Most peferred is m-phenylenediamine.

Aliphatic amines that can be used in the invention are those having at least bifunctionality. Examples of such aliphatic amines include piperazine, 2-methylpiperazine, 2-ethylpiperazine, 2,5-dimethylpiperazine, homopiperazine, t-2,5-dimethylpiperazine and like piperazine derivatives, bis(4-piperidyl)methane, 1,2-bis(4-piperidyl)ethane, 1,3-bis(4-piperidyl)propane, N,N′-dimethylethylenediamine, ethylenediamine, propylenediamine, propylenetriamine, N,N′-dimethylpropanediamine, 4-(aminomethyl)piperidine, cyclohexanediamine, and mixtures thereof. Aliphatic amines include amide prepolymers constituted from these amine compounds. Most preferred is piperazine.

Multifunctional acid halides that can be used in the invention include, for example, multifunctional acyl halides and may be aromatic or alicyclic. The multifunctional acid halides are those having at least bifunctionality and capable of reacting with the above-mentioned multifunctional amine to form a polymer. Preferred are aromatic or alicyclic, bi- or trifunctional acid halides. Examples thereof are trimesoyl halide, trimellitoyl halide, pyromellitoyl halide, benzophenonetetracarbonyl halide, isophthaloyl halide, terephthaloyl halide, diphenyldicarbonyl halide, naphthalenedicarbonyl halide, benzenedisulfonyl halide, chlorosulfonylisophthaloyl halide, pyridinedicarbonyl halide, and 1,3,5-cyclohexanetricarbonyl halide. In view of water permeability and organic substance removal performance, trimesoyl chloride, isophthaloyl chloride, terephthaloyl chloride, and mixtures thereof are preferred.

Solvents to be used in the multifunctional amine solution and the multifunctional acid halide solution are not particularly limited, so long as they can dissolve the multifunctional amine and the multifunctional acid halide, respectively, to form a liquid-liquid interface when these solutions are brought into contact with each other, and do no damage to the polysulfone porous membrane. The solvent of the multifunctional amine solution includes, for example, water. The solvent of the multifunctional acid halide solution includes, for example, hydrocarbon solvents such as n-hexane, cyclohexane, n-heptane, n-octane, n-nonane, n-decane and n-undecane, and mixtures thereof.

The concentrations of these multifunctional compounds may vary depending on their kinds and distribution coefficients with respect to solvents. For example, when piperazine is used as the multifunctional amine and the solvent thereof is water, and when trimesoyl chloride is used as the multifunctional acid halide and the solvent thereof is n-hexane, the concentration of piperazine is suitably about 0.1% to 10% by weight, preferably about 0.5% to 5% by weight, and the concentration of trimesoyl chloride is suitably about 0.1% to 10% by weight, preferably about 0.1% to 5% by weight. If these concentrations are below the respective lower limits, the formation of a ultrathin layer by interfacial polymerization will become imperfect, so that the ultrathin layer is liable to have defects, which may lower separation performance. If these concentrations are above the respective upper limits, the ultrathin layer becomes too thick, which may lower permeability performance, or the amount of unreacted matter remaining in the composite semipermeable membrane is increased, which may have an adverse effect on the membrane performance.

The present inventors further found that the concentration ratio of the multifunctional amine to the multifunctional acid halide significantly affects membrane performances of the resulting composite semipermeable membrane, and produced a defect-free composite semipermeable membrane by choosing the optimum concentration ratio. The optimum concentration ratio of the multifunctional amine concentration to the multifunctional acid halide is 20:1 to 0.1:1.

Further, if necessary, the following additives may be added to the multifunctional amine solution and/or the multifunctional acid halide solution.

When an acid is generated in the polycondensation reaction, an alkali as an acid acceptor may be added to the solution, or for the purpose of improving the wettability of the porous membrane, surfactants may be added to the solution. In addition, reaction accelerators for the respective multifunctional compounds may be added, if necessary. Examples of acid acceptors include caustic alkalis such as sodium hydroxide, sodium phosphates such as trisodium phosphate, pyridine, tertiary amines such as triethylenediamine and triethylamine and the like. Examples of surfactants include sodium laurylsulfonate and sodium laurylbenzenesulfonate. Examples of reaction accelerators include dimethylformamide. The concentrations of the acid acceptor, the surfactant and the reaction accelerators also greatly affect membrane performances. Their optimum concentrations can be easily determined from the results of experiments.

The temperatures of the multifunctional amine solution and the multifunctional acid halide solution are not particularly limited. When an interfacial polycondensation reaction readily proceeds between the multifunctional amine and the multifunctional acid halide at room temperature, their temperatures may be about room temperature, i.e., in the range of 5° C. to 45° C. If the temperatures are too high, the deterioration of multifunctional compounds or the evaporation of solvents will be accelerated. If these temperatures are too low, the following problems will arise. The polysulfone porous support membrane can not be sufficiently impregnated with the multifunctional amine solution. Furthermore, the interfacial reaction will proceed too slowly, giving incomplete formation of a polymeric ultrathin layer. Moreover, an excessively increased viscosity of the solvent will cause difficulty in the ultrathin layer production process.

In this specification, “bringing a polysulfone porous support membrane into contact with solutions” means applying the solutions to the polysulfone porous support membrane or immersing and passing the polysulfone porous support membrane through the solutions. After bringing the polysulfone porous support membrane into contact with the multifunctional amine solution, an excess of the solution remaining on the surface of the polysulfone porous support membrane is preferably removed therefrom because it causes the peeling of a ultrathin layer. For example, an excess of the solution can be removed by running the polysulfone porous support membrane in air for free fall and spontaneous drying, by scraping off the solution using an another liquid, by blowing air or an inert gas upon the membrane, or by drying the membrane with a dryer. After bringing the polysulfone porous support membrane into contact with the multifunctional acid halide solution, the polysulfone porous support membrane may be immersed in an aqueous solution of an acid acceptor for neutralization and termination of the reaction. Examples of acid acceptors include sodium phosphates such as trisodium phosphate, and sodium carbonate. In order to remove residual oligomers, unreacted monomers, surfactants, acid acceptors and reaction accelerators remaining in the membrane, the membrane may be washed with pure water, hot water, an aqueous acid solution, an aqueous alkali solution, an organic solvent, an aqueous organic solvent solution, an aqueous oxidizing agent solution, an aqueous reducing agent solution or the like.

The following examples illustrate processes for producing the composite semipermeable membranes of the invention in the form of hollow fiber membranes, the membranes having high water permeability and high separation performance. Whether it is in the form of a flat-sheet membrane or a tubular membrane, the only difference lies in shape of sulfone porous support membrane. The semipermeable membranes in the form of flat-sheet membranes or tubular membranes can be produced essentially by similar techniques as mentioned below, having high water permeability and high separation performance.

### BEST MODE FOR CARRYING OUT THE INVENTION

The present invention will be described below in more detail with reference to Examples and Comparative Examples. The invention, however, is not limited to the Examples. The performances and infrared absorption spectra shown in Examples and Comparative Examples were measured by the following methods under the conditions shown below.

(1) Aqueous Sucrose Solution Separation Performance of Composite Hollow Fiber Membrane

First, mini-modules were prepared using porous hollow fibers obtained in Examples 1-6 and Comparative Examples 1-2 in the following manner. Fifty-four hollow fibers(obtained in Examples 1-6 and Comparative Example 2) or eighteen hollow fibers(obtained in Comparative Example 1) were bundled in the form of loops. One end of the hollow fibers was inserted into a holder and fixed using an epoxy resin. The hollow fibers were cut at the end to open the hollow fibers, thus providing a mini-module comprising the porous hollow fibers having an effective length of 38.5 cm and a membrane area of 457(Examples 1-6 and Comparative Example 2) or 152(Comparative Example 1) cm² measured based on the outer diameter of the hollow fibers.

80 g of sucrose was dissolved in 80 L of RO water to obtain a 1000 mg/L aqueous solution. The aqueous solution was supplied to the outer surface of the composite hollow fiber membrane in the mini-module at a water temperature of 25° C., under a pressure of 0.30 MPa, at a membrane surface average flow rate of 13 cm/second and at a permeate recovery ratio of less than 1%. The permeate recovery ratio RC is defined by the following equation:

RC(%)=Qp+L/Qf×100

Qp: Flow volume of permeate per unit time

Qf: Flow volume of feed per unit time

One hour later, permeate was sampled to determine the flow volume per unit time and sucrose concentration. Water permeability was expressed by the volume of the permeate per unit membrane area (m²) per unit time (day). Removal percentage Rj indicating removal performance was defined by the equation shown below. Sucrose concentration was determined by the colorimetry with anthrone-sulfuric acid method.

Rj(%)=(1−Cp/Cf)×100

Cp: Sucrose concentration of permeate

Cf: Sucrose concentration of feed

(2) ATR Infrared Absorption Spectrum

After the composite hollow fiber membrane was heated at 80° C. and dried under reduced pressure overnight, ATR infrared absorption spectra were measured on the outer surface of the composite hollow fiber membrane. The hollow fiber membrane was halved on the plane roughly parallel to the fiber axis and used as a measurement sample. Spectra were measured using IR μs/SIRM manufactured by SPECTRA TECH and using diamond(incident angle is 45°) as an internal reflection element, at a spectral resolution of 8 cm⁻¹ and integrated 64 times. Apodization in the Fourier transform was done using Happ-Genzel function. Spectra were measured at twenty points on the hollow fiber membrane outer surface. The average value of absorption intensity ratio T₍ᵢ₎ defined by the following equation was termed absorption intensity ratio T of the composite hollow fiber membrane. The subscript (i) means that the value was obtained at the measurement position numbered i, and i represents an integer of 1+L-12.

T_{(i)+L=A}a_{(i)+L/A}s_{(i)+L}

Aa₍ᵢ₎: absorption intensity at the absorption peak revealing C═O of polyamide in the region of 1600-1700 cm⁻¹ at the measurement position numbered i.

As₍ᵢ₎: absorption intensity at the absorption peak revealing polysulfone around 1586 cm⁻¹ at the measurement position numbered i.

The value T₍ᵢ₎ fluctuates with the degree of contact with pressure between the internal reflection element and the sample. The higher the degree of contact is, the lower the value T is. In the present invention, spectra were measured at each measurement point several times while increasing the degree of contact with pressure, and the value that did not decrease any more with a further increase of contact was used as T₍ᵢ₎. The base line for calculating absorption intensity was drawn in the following manner. In the calculation of the absorption intensity of the absorption peak revealing C═O of polyamide in the region of 1600-1700 cm⁻¹, a base line was drawn by connecting the left edge of this peak and the right edge of the peak revealing polysulfone around 1586 cm⁻¹. In the calculation of the absorption intensity of the absorption peak revealing polysulfone around 1586 cm⁻¹, a base line was drawn by connecting the both edges of this absorption. These base lines were drawn not to cross the spectrum.

### EXAMPLE 1

A spinning stock solution containing 20% by weight of polysulfone resin (Teijin Amoco Engineering Plastics Limited, Udel P-3500), 4% by weight of triethyleneglycol, 0.5% by weight of sodium laurylbenzenesulfonate and 75.5% by weight of dimethylacetamide was emitted from the outer portion of a nozzle with a double-tube structure used for the production of hollow fibers, whereas an aqueous solution of 30% by weight of dimethylacetamide and 70% by weight of water was emitted from the inner core portion of the nozzle. These solutions were passed through an air travel portion 6 cm in length and spun into a coagulation bath containing water as a main component, at a rate of 15 m/minute, thus giving a polysulfone porous hollow fiber support membrane. Thereafter, the membrane was washed with water to remove residual solvent and treated with hot water at 70° C. Subsequently an aqueous amine solution (2.0% by weight of piperazine, 1.0% by weight of triethylenediamine, 0.065% by weight of sodium laurylbenzenesulfonate in RO water) was prepared. The porous hollow fiber membrane was successively immersed in and passed through the solution. During the above operation, the composition of the aqueous amine solution was kept constant. After removing an excess of the aqueous amine solution from the outer surface of the porous hollow fiber membrane, the porous hollow fiber membrane was successively brought into contact with a solution of 0.96 wt. % trimesoyl chloride in n-hexane, Fluorinert FC-70 (sold by Sumitomo 3M), an aqueous solution of 1 wt. % acetic acid and heated in a drying tower. The resulting membrane was washed in a water washing bath to give a composite hollow fiber membrane having a ultrathin layer of a crosslinked polypiperazineamide on the outer surface. The absorption intensity ratio T of the obtained composite hollow fiber membrane in an ATR infrared absorption spectrum was 0.54. The sucrose removal measured under the conditions mentioned above was 95.6%, water permeability was 272 L/m²/day.

### EXAMPLE 2

A composite hollow fiber membrane was prepared in the same manner as in Example 1, except that the concentration of trimesoyl chloride in the n-hexane solution was changed to 0.85% by weight. The absorption intensity ratio T, sucrose removal and water permeability were 1.02, 95.8% and 211 L/m²/day, respectively.

### EXAMPLE 3

A composite hollow fiber membrane was prepared in the same manner as in Example 1, except that the concentration of triethylenediamine in the amine aqueous solution was changed to 2.0% by weight and the concentration of trimesoyl chloride in the n-hexane solution was changed to 0.75% by weight. The absorption intensity ratio T, sucrose removal and water permeability were 0.16, 95.2% and 384 L/m²/day, respectively.

### Comparative Example 1

The procedures shown in Example 1 were discontinued at the stage before impregnation with the aqueous amine solution, thus providing a hollow fiber membrane. The absorption intensity ratio T, sucrose removal and water permeability of the membrane were 0.00, 0.0% and 12000 L/m²/day, respectively.

### Comparative Example 2

A composite hollow fiber membrane was prepared in the same manner as in Example 1 except that the contact time with the n-hexane solution of 0.96 wt. % trimesoyl chloride was 10 times as long as the contact time in Example 1. The absorption intensity ratio T, sucrose removal and water permeability of the membrane were 3.5, 97.2% and 73 L/m²/day, respectively.

### EXAMPLES 4-6

A spinning stock solution containing 20% by weight of polysulfone resin (Teijin Amoco Engineering Plastics Limited, Udel P-3500), 4% by weight of triethyleneglycol, 0.5% by weight of sodium laurylbenzenesulfonate and 75.5% by weight of dimethylacetamide was emitted from the outer portion of a nozzle with a double-tube structure used for the production of hollow fibers, whereas an aqueous solution of 30% by weight of dimethylacetamide and 70% by weight of water was emitted from the inner core portion of the nozzle. These solutions were passed through an air travel portion 6 cm in length and spun into a coagulation bath containing water as a main component, at a rate of 15 m/minute, thus giving a polysulfone porous hollow fiber membrane. Thereafter, the membrane was washed with water to remove residual solvent. An aqueous amine solution (2.0% by weight of piperazine, 1.0% by weight of triethylenediamine and 0.065% by weight of sodium laurylbenzenesulfonate in RO water) was prepared. The porous hollow fiber membrane was immersed in and passed through the solution. During the above operation, the composition of the aqueous amine solution was kept constant. After removing an excess of the aqueous amine solution from the surface of the porous hollow fiber membrane, the porous hollow fiber membrane was successively brought into contact with a n-hexane solution of acid chlorides having the composition shown in Table 1, Fluorinert FC-70, an aqueous solution of 1 wt. % acetic acid and heated in a drying tower. The resulting membrane was washed in a water washing bath to give a composite hollow fiber mebrane having a ultrathin layer of a crosslinked polypiperazineamide on the outer surface. Table 1 shows absorption intensity ratio T of the obtained composite hollow fiber membrane in an ATR infrared absorption spectrum, water permeability and sucrose removal measured under the conditions mentioned above.

TABLE 1

| | | | | Infra- | | |
|---|---|---|---|---|---|---|
| | | | | red | Membrane | |
| | Acid chloride composition | | | absorp- | performance | |
| | Tri- | Iso- | Charg- | tion | | Water |
| | mesoyl | phthaloyl | ing | inten- | | Permea- |
| | chloride | chloride | weight | sity | Removal | bility |
| EX. | (wt. %) | (wt. %) | ratio | ratio T | (%) | (L/m²/day) |
| 4 | 0.90 | 0.10 | 90/10 | 0.93 | 96.6 | 270 |
| 5 | 0.60 | 0.60 | 50/50 | 0.49 | 96.2 | 301 |
| 6 | 0.30 | 0.70 | 30/70 | 0.48 | 95.7 | 269 |

The composite semipermeable membrane of the invention comprises a polysulfone porous support membrane and a polyamide ultrathin layer formed on one of the surfaces, and thus has excellent water permeability, high separation performance and particularly excellent organic substance removal performance. The composite semipermeable membrane of the invention is useful as a reverse osmosis membrane for desalination of brackish water and seawater or for preparation of ultrapure water for manufacturing semiconductors. The composite semipermeable membrane of the invention can be used as a nano-filtration membrane in various fields, for example, in small equipment for producing pure water, water purifiers, water purifiers for producing highly purified water, recovery of valuable matter, and treatment of waste water.

### BRIEF DESCRIPTION OF DRAWINGS

FIG. 1 shows an ATR infrared absorption spectrum obtained from the surface of the polysulfone porous hollow fiber membrane produced in Comparative Example 1.

FIG. 2 shows an ATR infrared absorption spectrum obtained from the outer surface of the composite hollow fiber membrane produced in Example 1.

FIG. 3 shows an ATR infrared absorption spectrum of the polyamide obtained by separation from the outer surface of the composite hollow fiber membrane produced in Example 1.

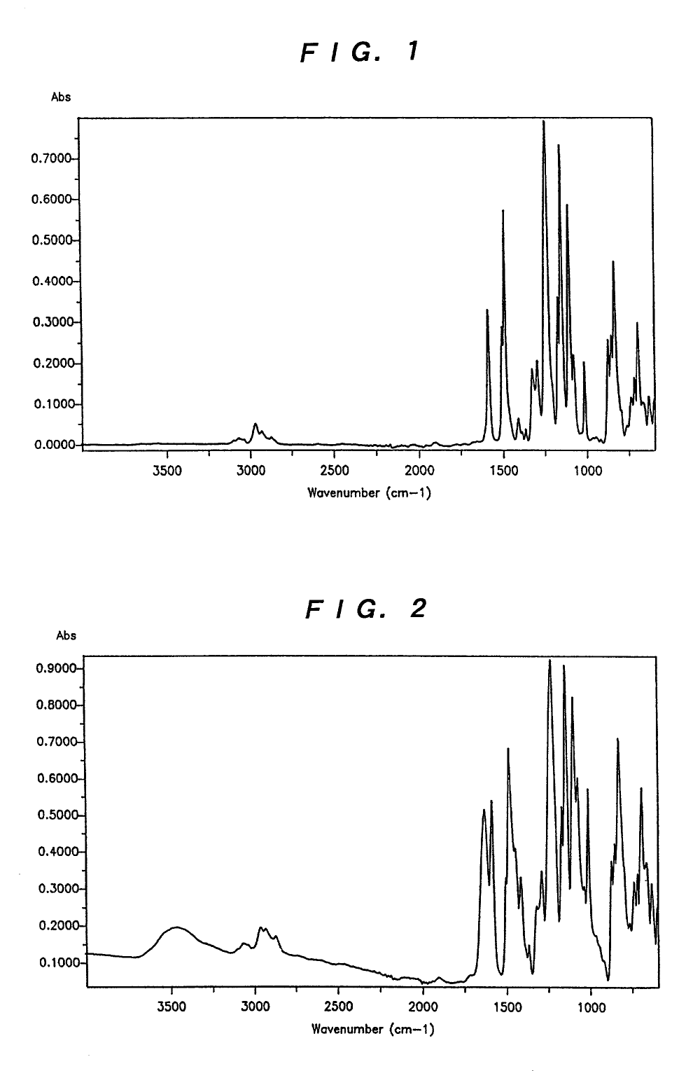

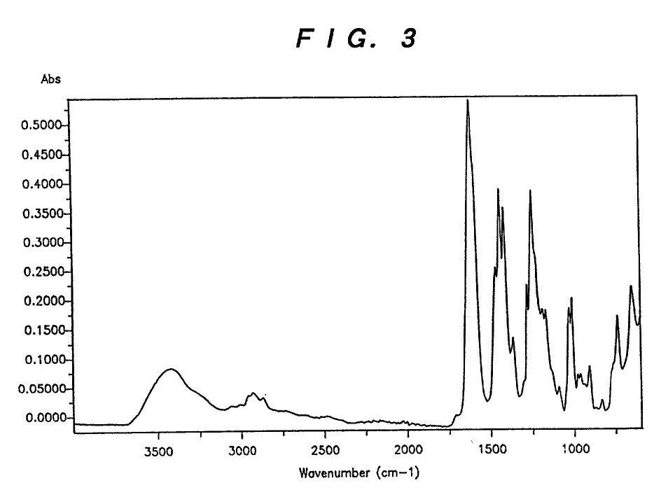

1. A composite semipermeable membrane comprising a polysulfone porous support membrane and a polyamide ultrathin layer formed on one of the surfaces of the porous support membrane, the composite membrane having the characteristic that in the infrared absorption spectrum obtained from the surface of the polyamide ultrathin layer of the composite semipermeable membrane, the ratio T (=Aa/As) of absorption intensity Aa at the absorption peak revealing C═O of polyamide in the region of 1600-1700 cm⁻¹ to absorption intensity As at the absorption peak revealing polysulfone at a wavenumber around 1586 cm⁻¹ is at least 0.05 and not higher than 3.

2. The composite semipermeable membrane according to claim 1 wherein the ratio T (=Aa/As) is at least 0.1 and not higher than 1.5.

3. The composite semipermeable membrane according to claim 1 wherein the polyamide comprises a crosslinked polyamide.

4. The composite semipermeable membrane according to claim 1 wherein the polyamide comprises a crosslinked polypiperazineamide.

5. The composite semipermeable membrane according to claim 1 whose sucrose removal is 92% or more and whose water permeability is 0.2 m³/m²/day or more, with respect to 0.1 wt. % aqueous sucrose solution, under an operating pressure of 0.3 MPa at a temperature of 25° C. and at pH of 6.5.

6. The composite semipermeable membrane according to claim 1 which is in the form of a hollow fiber membrane.

7. The composite semipermeable membrane according to claim 6 wherein the polyamide ultrathin layer is formed on the outer surface of the hollow fiber membrane.

8. A process for producing a composite semipermeable membrane as set forth in claim 1, comprising forming a polyamide ultrathin layer on one of the surfaces of a polysulfone porous support membrane by carrying out an interfacial polycondensation reaction between at least one multifunctional amine and at least one multifunctional acid halide on one of the surfaces of a polysulfone porous support membrane.

9. The process according to claim 8 wherein the interfacial polycondensation reaction is carried out by:
(i) bringing the polysulfone porous support membrane into contact with a controlled concentration of a multifunctional amine solution; and
(ii) bringing the membrane into contact with a controlled concentration of a multifunctional acid halide solution.

10. The process according to claim 8 wherein the composite semipermeable membrane is in the form of a hollow fiber membrane.

11. The process according to claim 9 wherein the concentration ratio of the multifunctional amine to the multifunctional acid halide is 20:1 to 0.1:1.
